(19) United States
(12) Patent Application Publication
(10) Pub. No.: US 2026/0281671 A1
(43) Pub. Date: Sep. 17, 2026

(54) SYSTEMS AND METHODS FOR BONDED AND VETTED PHONE TRANSMISSIONS

(71) Applicant: Ford Global Technologies, LLC, Dearborn, MI (US)

(72) Inventors: Keith Weston, Canton, MI (US); John Robert Van Wiemeersch, Novi, MI (US); Brendan Diamond, Naples, FL (US)

(73) Assignee: Ford Global Technologies, LLC, Dearborn, MI (US)

(21) Appl. No.: 19/076,409

(22) Filed: Mar. 11, 2025

(51) Int. Cl. H04W 4/16; H04M 3/42; H04M 3/428; H04W 4/021; H04W 4/12; H04W 4/44; H04W 8/18

(52) U.S. Cl. CPC H04W 4/16; H04M 3/42059; H04M 3/4283; H04W 4/021; H04W 4/12; H04W 4/44; H04W 8/183

(57) ABSTRACT

Systems and methods for screening and rejecting unwanted phone calls are provided. A user may designate a list of phone numbers as being preauthorized. A phone call from any of these numbers will be put through automatically to the user device. If an incoming phone call is not from any of these preauthorized phone numbers, the user device may send information to the calling device about securing a bond before the phone call is put through. If the caller purchases the bond, the user device verifies this and allows the call to be connected to the user device. If the bond is not purchased, the call is denied. In other instances, the user may designate calls originating from within certain geographic areas or area in proximity to one or more preauthorized vehicles to be allowed, even if the incoming phone number is not part of the preauthorized list of phone numbers.

### FIELD

The present disclosure relates to the field of phone communication. Specifically, embodiments of the present disclosure relate to methods and systems for bonded and vetted phone communications.

### BACKGROUND

Unwanted and robo phone calls have become a pervasive nuisance, causing inconvenience, frustration, and other issues. These calls range from automated telemarketing pitches to more nefarious attempts like phishing scams and fraudulent schemes. The issue has grown exponentially due to technological advancements that enable robo callers to easily generate large volumes of calls using auto-dialing systems and spoofed phone numbers. This not only wastes time but also poses significant consequences, particularly when these calls are received while driving a vehicle. For drivers, answering or reacting to these calls while on the road can lead to reduced awareness of the surroundings.

While there are some solutions in existence today to reduce the amount of these calls received by the users, there is a need for a more robust way of eliminating such calls.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 is a flow diagram of a process for screening phone calls according to an embodiment of the present disclosure.

FIG. 4 is a flow diagram of a process for adding a number to a blocked number list according to an embodiment of the present invention.

FIG. 5 illustrates a flow diagram of a process according to another embodiment of the present invention.

FIG. 6 illustrates a flow diagram for a process according to yet another embodiment of the present disclosure.

FIG. 7 illustrates a block diagram of a server according to an embodiment of the present disclosure.

### DETAILED DESCRIPTION

### Overview

The present disclosure describes systems and methods for eliminating unwanted telephone calls. Specifically, embodiments of the present disclosure relate to systems and methods for reducing or eliminating unwanted and/or unsolicited phone calls by requiring the calling party to purchase a monetary bond in order to be connected to the concerned party.

Embodiments of the present disclosure provide a method. This includes a first device receiving a first phone call from a second device. The method further includes the first device determining that a phone number associated with the second device is not part of a preauthorized list of phone numbers. The method then includes the first device sending to the second device a first message including information about purchasing a bond in order for the first phone call to proceed and thereafter receiving a second message indicative of the bond being purchased. The method finally includes the first device accepting the first phone call based on the bond being purchased.

In another instance, a method is provided that includes receiving, by a first device, a first phone call from a second device and determining, by the first device, that a phone number associated with the second device is not part of a preauthorized list of phone numbers. The method further includes determining, by the first device, whether a current location of the second device is within a predetermined geographic area, wherein the predetermined geographic area is associated with a user of the first device. Thereafter the method includes determining, by the first device, whether the current location of the second device is proximate to a current location of one or more preauthorized vehicles, wherein the one or more authorized vehicles are associated with a user of the first device, and allowing, by the first device, the first phone call to proceed if the current location of the second device is within the predetermined geographic area or if the current location of the second device is proximate to the current location of one or more preauthorized vehicles.

In yet another instance, a vehicle is provided that may include an automotive computer including a communication interface configured to communicate over a mobile phone network, and a memory device coupled to the vehicle control unit and storing instructions that, when executed by the controller, causes the automotive computer to perform one or more operations. The instructions may cause the automotive computer to receive a first phone call from a first device, determine that a phone number associated with the first device is not part of a preauthorized list of phone numbers, place the first phone call on hold, send a first message to the first device, the first message instructing a user of the first device to purchase a bond, receive a second message indicating that the user of the first device has purchased the bond, and allowing the first phone call to proceed based on the bond being purchased.

These and other advantages of the present disclosure are provided in detail herein.

### Illustrative Embodiments

The disclosure will be described more fully hereinafter with reference to the accompanying drawings, in which example embodiments of the disclosure are shown and not intended to be limiting.

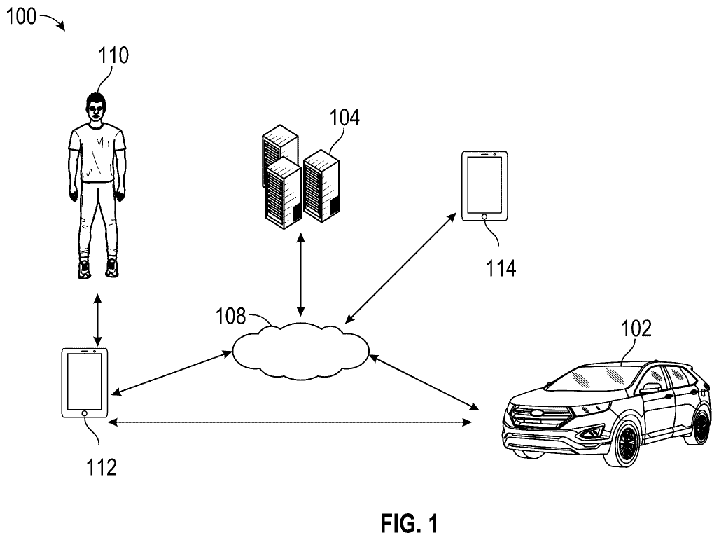

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. In an embodiment, the server 104 may be associated with a bond provider entity. The bond provider entity may be a company or financial institution that guarantees a bond on behalf of an individual or business. The bond acts as a financial security instrument, ensuring that a specific obligation, contract, or duty will be fulfilled. If the individual or business does not meet their obligations, the bond provider compensates the aggrieved party up to the bond amount and then seeks reimbursement from the bonded party. Details of the control server 104 are provided below with reference to FIG. 10.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may communicate directly with the user device 112 to send and receive data without the need for the network 108 and/or the server 104. The environment 100 may include a second device 114. The second device 114 may be similar to the user device 112. In an embodiment, both the user device and the second device 114 may be able to place and accept phone calls and/or text messages via several different methods. In other embodiments, the user device 112 may be integrated into the vehicle 102 such that the second device 114 may be used to place a phone call that the user 110 may accept using an interface/component of the vehicle 102. In some embodiments, the second device 114 may include any system or device that can place a call. For example, the second device 114 may include any combination of a cellular phone, an internet device (IP phone), a computer, a landline that is channeled to a cellular or satellite phone, and the like.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies, such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

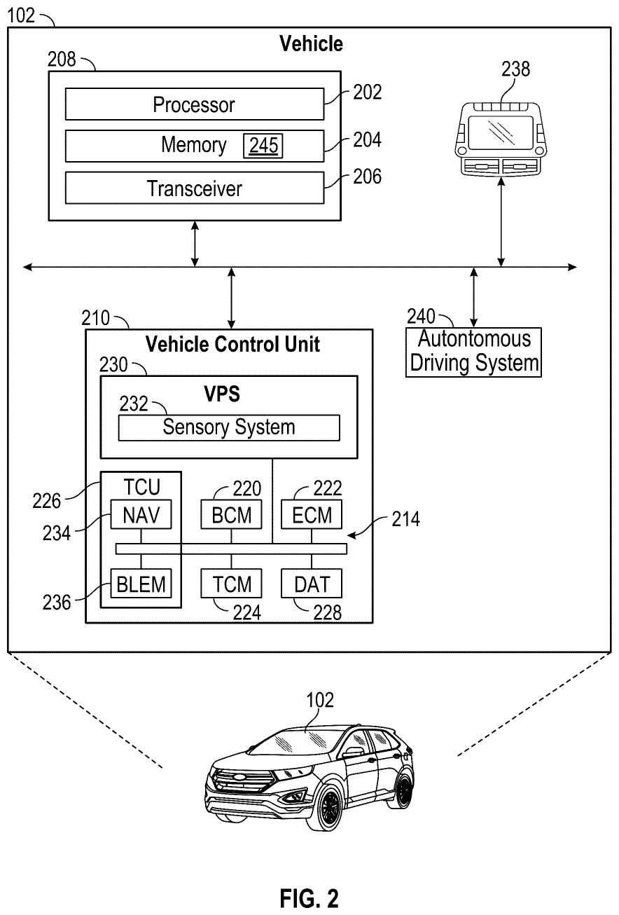

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 that are in communication with the automotive computer 208. In an embodiment, the automotive computer 208 may include hardware that can be used to communicate over a mobile network. Such hardware may include a cellular radio module, a subscriber identity module (SIM), RF transceiver, GPS module, and an application processor. The automotive computer 208 may also include software such as baseband firmware, radio interface layer, protocol stack software, SIM toolkit, dialer ad messaging applications, network configuration and security software, etc.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices that are in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory, computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more configurations. For example, the various sensors of the vehicle sensory system 232 may be integrated into the various subsystems of the vehicle 102, such as doors, mirrors, roof, etc. or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled with the vehicle in various ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and offboard the vehicle 102 and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), wipers, door locks and access control, various comfort controls, etc. The BCM 220 also may operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 also may provide aspects of user and environmental inputs that are usable for user authentication.

In some embodiments, the automotive computer 208 may connect with an infotainment system 238 (or a vehicle Human-Machine Interface (HMI)). The infotainment system 238 may include a touchscreen interface portion and voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc. on the touchscreen interface portion. In some embodiments, the user device 112 may provide the HMI interface.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and subsystems. A chassis, frame, or unibody may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 also may include a transmission system. The transmission system transfers the engine's power to the wheels. It includes the clutch, gearbox, driveshaft, and differentials, among other components. The transmission adjusts the power output to suit the vehicle's speed and load. The vehicle 102 also may include a suspension system. The suspension system absorbs shocks and maintains contact between the tires and the road, providing a smooth ride. It includes components such as springs, shock absorbers, and linkages. The vehicle 102 also includes a vehicle-stopping system that allows the driver to slow down or stop the vehicle 102. It includes components like pedals, master cylinders, lines, and pads or shoes. The vehicle 102 also includes a steering system that enables the driver to guide the car. The steering system includes components such as the steering wheel, steering column, rack and pinion, and tie rods. The vehicle 102 may further include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 may also include a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All the mechanical components working together ensure that the vehicle 102 operates optimally.

Robo calls and other unwanted calls are a reality of modern life. When a phone rings while driving, especially from an unknown number, it can create a sudden situation. The instinctive reaction to check who is calling may cause the driver to take their eyes off the road, even if only for a few seconds. According to the National Highway Traffic Safety Administration (NHTSA), taking your eyes off the road for five seconds at 55 mph is equivalent to driving the length of a football field blindfolded. This kind of unawareness can be an issue when caused by unexpected and frequent robo calls, which can come at any time without prenotification.

Many drivers use their phones for navigation or music, and these unwanted calls may cause issues with their awareness. When a call comes through, drivers may instinctively glance at their screen, inadvertently increasing cognitive load and reducing reaction times. Even the use of handsfree devices may not alleviate this issue. Some Robo calls may be designed to create a sense of urgency or fear, especially when they involve scams pretending to be from government agencies, utility companies, or financial institutions. Receiving such a call while driving can cause emotional distress, potentially impairing the driver's judgment and focus. In some cases, drivers may feel compelled to respond immediately, either out of confusion or fear of missing an important call. Efforts to combat unwanted and robo calls have intensified in recent years, with policies like the Telephone Robocall Abuse Criminal Enforcement and Deterrence (TRACED) Act and advancements in call-blocking technology. Despite these measures, the issue persists, largely due to the ease with which robo callers can bypass precautions using spoofing techniques and constantly evolving tactics.

Embodiments of the present disclosure provide systems and methods to effectively counter such unwanted and robo calls and also provide techniques for benefitting financially from these unwanted callers.

When the user dials a phone number and presses the call button, the mobile device communicates with the nearest cell tower (also called a base station or eNodeB in LTE networks). The device sends a channel request signal to establish a connection with the network. This request includes the dialed phone number and other necessary information like the user's identity (e.g., stored on the SIM card) and the type of service required (e.g., voice call). The mobile network's core infrastructure receives the request and begins authentication and verification of the caller's identity and subscription status. This process is handled by the Home Location Register (HLR) or Authentication Center (AUC). The network checks whether the caller is authorized to make calls and ensures there are no restrictions (e.g., account suspension). The network determines how to route the call based on the dialed number. If the call is local (e.g., within the same operator's network), the call is routed directly through the mobile switching center (MSC). If the call is to a different network (e.g., domestic or international), the MSC forwards it to the appropriate external network, such as the Public Switched Telephone Network (PSTN) for traditional landline connections or other mobile networks. The network locates the recipient's device by querying the Visitor Location Register (VLR) and identifying to which cell tower the recipient is connected. Once authentication is complete, the network assigns a temporary communication channel and proceeds with call setup.

Once the recipient's device is found, the network sends a signal to the recipient's device, causing it to ring. This process involves the paging request, where the network broadcasts a signal to the recipient's device through the nearest cell tower. If the recipient's device is turned on and connected to the network, it responds with a paging response, indicating its readiness to accept the call. When the recipient answers the call, the network establishes a full-duplex communication channel between the calling device and the recipient's device. Voice data is then transmitted in real time using circuit-switched (CS) technology in 2G/3G networks or Voice over LTE (VoLTE) in 4G and 5G networks. The call is maintained through continuous communication between the mobile devices and the network's core infrastructure, with handoffs to different cell towers if either the calling user or the recipient user is moving. When either party ends the call, a call release message is sent to the network. The network then releases the communication channel and frees up resources. Both calling device and the recipient's device return to idle mode, ready for the next activity.

The recipient or the originator may place the phone call on hold. While the phone call is on hold, both the recipient's device and the calling device may communicate with each other using SMS or other messaging apps, browse the Internet, or use other apps that use data.

In case of a text message, the process may begin with the originating user typing a message on his/her device. The device may use any of the multiple protocols for sending the message. These protocols may include short message peer-to-peer protocol (SMPP), universal mobile telecommunications system (UMTS), or long-term evolution (LTE) protocols depending on the network generation (2G/3G/4G/5G). The message can be standard SMS (160 characters max for GSM 7-bit encoding) or concatenated (multi-part) for longer texts. The originating device then communicates with the nearest base transceiver station (BTS). This step converts the message into a digital format and sends it over the air interface. The over-the-air interface may include global system for mobile communication (GSM), UMTS, LTE or 5G new radio (NR) protocols. The BTS forwards the message to the core network and routes it to the short message service center (SMSC), which acts as a store-and-forward server. The SMSC queries the Home Location Register (HLR) or Home Subscriber Server (HSS) to get the recipient's status and location information (e.g., current MSC). The message is forwarded to the recipient's device via the nearest BTS. The message is received and stored in the recipient's device memory or SIM card. The user is notified via a message alert.

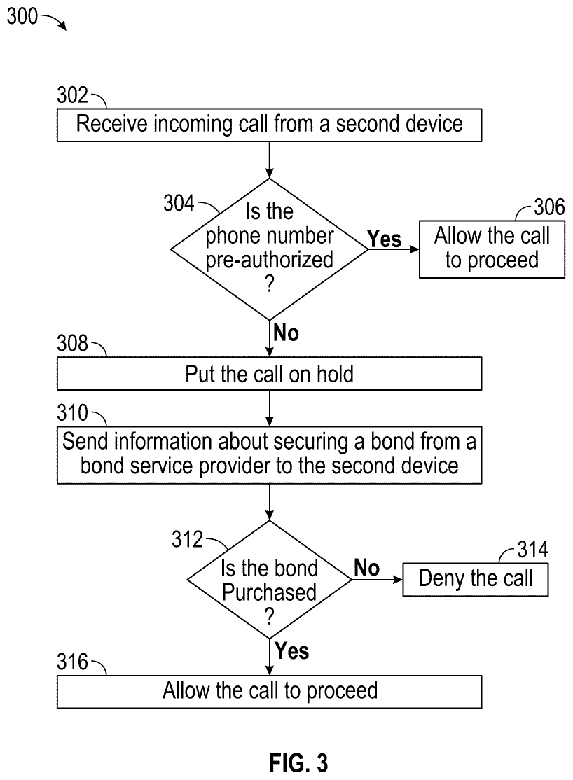

FIG. 3 illustrates a flow diagram of a process 300 according to an embodiment of the present disclosure. The process 300 may be performed by the user device 112 or the automotive computer 208 of the vehicle 102 for FIG. 1, or a combination thereof. At step 302, a first device (e.g., user device 112 or the vehicle 102) may receive a call from a second device. As noted above, the call may be a traditional voice phone call or a message. The second device may be associated with a second user or an entity and have an associated phone number. Once the call is received at the first device, the first device may check whether the phone number associated with the second device is a preauthorized phone number, at step 304. The user of the first device may preauthorize one or more phone numbers. For example, the user of the first device may designate phone numbers associated with friends and family members as authorized phone numbers. The user of the first device may designate any phone number as being authorized based on his/her wish. In an embodiment, the first device may store a list of the preauthorized phone numbers that the user of the first device has designated as such.

If at step 304, the first device determines that the phone number associated with the incoming call is part of the preauthorized phone numbers, the first device may allow the call to proceed, at step 306. For example, if the phone number associated with the incoming call is part of the preauthorized phone numbers the first device may send the paging response explained above indicating it is ready to accept the call. The first device may then start ringing or display a notification that a message has arrived. If at step 304, it is determined that the phone number associated with the incoming call is not part of the preauthorized phone numbers, then the incoming call is placed on hold at step 308. Concurrently or after the incoming call is placed on hold, the first device sends information to the second device about securing a monetary bond if the user of the second device wishes for the call to proceed, at step 310. The information sent to the second device may include information about one or more bond service providers, amount of money to be posted for the bond, and an amount of time that the phone call will be permitted. The information may be sent via an SMS or via a messaging application. Thus, while the phone call is being processed via a first communication channel, the first device may send the information at step 310 via a second communication channel that is different from the first communication channel. For example, the information sent to the second device may say something like, “Please post a bond worth $xx at [bond service provider name] for a total call duration of yy mins.” In some embodiments, the information may further include details of whether the bond is refundable or nonrefundable upon conclusion of the phone call.

In an embodiment, in order to secure/purchase the bond, the first device may send a link to the second device via SMS or a messaging application. The person operating the second device (i.e., the second user) may then access the link and visit the website of the bond service provider and enter the requested information. Since the phone call is on hold during this time, the first device and the second device are still connected; while the bond securing process is being conducted in parallel. The second user may pay the bond amount using credit/debit card, bank transfer, or using a mobile payment platform. The bond service provider may then issue an electronic bond to the second person and send the details of the electronic bond to the second device and the first device. In another instance, the second user may forward the details of the electronic bond to the first device. The first user may then verify the details of the bond to ensure that the bond is valid. In other embodiments, unstructured supplementary service data (USSD) code, SMS-based transfers, agent-assisted transactions, or mobile money wallets may be used by the user of the second device to complete the bond buying transaction in the event that the second device is not a smart phone.

In some embodiments, the user of the first device may designate different monetary amounts for different durations of the phone call. For example, $1 for a one-minute phone call, $10 for a five-minute phone call, etc. In this manner, the user of the first device may screen out unwanted or robo callers. People who genuinely want to talk to the user of the first device for a legitimate purpose may pay the bond amount to talk to the user of the first device. If the user of the second device wants to talk to the user of the first device, the user of the second device may purchase the bond based on the information received from the first device. Once the bond is purchased, the bond service provider may send a message to the first device indicating that the bond was purchased. At step 312, the first device may confirm whether the bond was purchased in accordance with the instructions sent at step 310. In an embodiment, the bond service provider may send a message to the first device confirming the purchase of the bond and providing details of the user of the second device, the amount of bond purchased, etc. In some instances, the user of the second device may choose not to purchase the bond and instead simply hang up after receiving the message at step 310. In that instance, the first device may determine that the bond was not purchased and may deny or terminate the call at step 314. If at step 312, the first device determines that the bond was purchased, the first device may allow the call to proceed at step 316. In some embodiments, prior to connecting the call, the first device may send a message to the second device indicating the amount of time allocated for the phone call. In this instance, upon expiration of the allocated time duration, the phone call may be automatically terminated.

In an embodiment, the amount of bond money requested may depend on the user or entity associated with the phone number of the second device. For example, if the phone number belongs to a charitable organization, a low amount such as $1 may be requested as the bond money. In other instances, where the phone number is associated with telemarketing agencies or display a “unknown” or “blocked number,” the amount of the bond may be set at a higher number such as, $10 to discourage these entities from calling. The bond amounts may also be configured based on time of the day, time of year, and other temporal considerations. In some embodiments, the user of the first device may allow calls from any phone number by using a challenge/response system. For example, the first device automatically may ask the user of the second device to answer one or more questions about the user of the first device in order ascertain whether the user of the second device is a genuine caller. In other instances, the user of the second device may be asked to solve a simple mathematical test or answer a multiple-choice question before the call is connected.

In some instances, the settings for accepting a call may be based on the vehicle state of motion. For example, if the vehicle is in motion, only calls from certain people (e.g., immediate family, a kid's school, etc.) may be allowed; while other calls may be blocked or automatically sent to a voice mail. In certain instances, any incoming call from a second device may be put on hold initially, and the message to post a bond may be sent to the second device. However, the user of the first device may provide a passcode to certain individuals (e.g., friends and family) so that they can bypass the bond requirement. In one embodiment, if the phone number of the incoming call is determined to be one of the preauthorized numbers (e.g., at step 304), then at step 310, the first device may send the bypass code along with the information about posting the bond to the second device. The user of the second device or the second device itself may then enter the bypass code, and the call may be allowed to proceed. In other embodiments, where the user or entity associated with the second device wants to pay the bond but does not have enough funds available at that moment, does not have the means to pay for the bond, and/or does not know how to actually pay the bond, they may indicate their willingness to pay the bond (e.g., via a touch tone key entry). Thereafter, the call may be routed to a call center with whom the user of the first device has established a service for this purpose. The call center may help identify the user of the second device, help to ascertain the importance of the call, and/or help the user of the second device to pay for the bond and then reconnect the phone call to the first device.

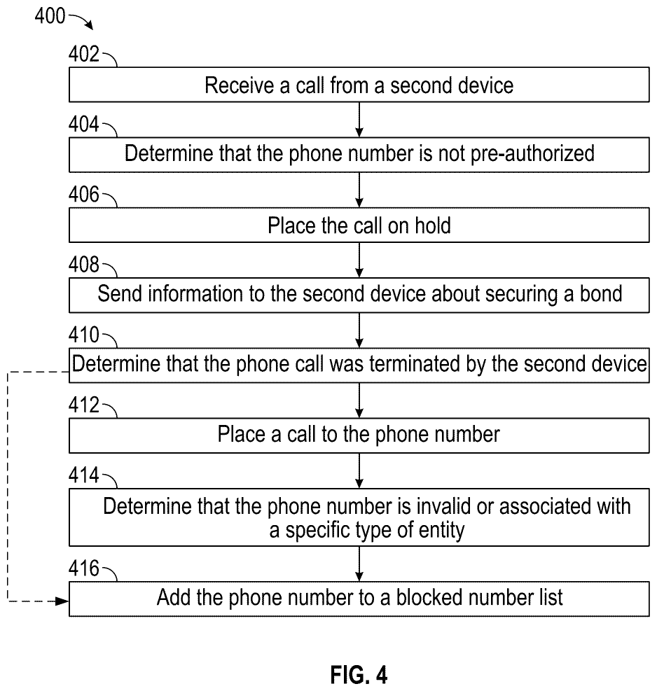

FIG. 4 illustrates a flow chart for a process 400 according to another embodiment of the present disclosure. Process 400 may be performed by the user device 112, the automotive computer 208 of the vehicle 102, or a combination thereof. At step 402, a first device (e.g., user device 112) associated with a first user may receive a call from a second device (e.g., user device 114) belonging to a second user/entity. At step 404, the first device may determine that the phone number associated with the second device is not a preauthorized phone number. In response to the determination at step 404, the first device may place the call on hold at step 406 and send a message to the second device about securing a bond if the second user wished for the phone call to proceed at step 408. If the second user decides to forgo the conversation with the first user, the second user may hang up and terminate the call. At step 410, the first device may determine that the phone call has been terminated. Based on that, the first device may determine that the phone number associated with the second device may be spam or another unwanted call. At step 412, the first device may place a call to the phone number associated with the second device. In other words, the first device may dial-back the same phone number it received at step 402.

At step 414, the first device may determine that the phone number is associated with a certain entity, is a disconnected number, is an invalid number, or the like. This may be an indication that the phone number is likely of no interest to the first user and may belong to a robo caller or a scammer entity. Based on this determination, the first device may include the phone number in a blocked number list, at step 416. Any further calls from that number may be blocked automatically by the first device. In this manner, suspicious phone numbers can be blocked automatically by the first device even without the intervention of the user of the first device. In some embodiments, if the first device determines that the phone call was terminated by the second device at step 410, the process 400 may proceed directly to step 416 where the first device may add the phone number to the blocked number list. In this instance, steps 412 and 414 may be bypassed.

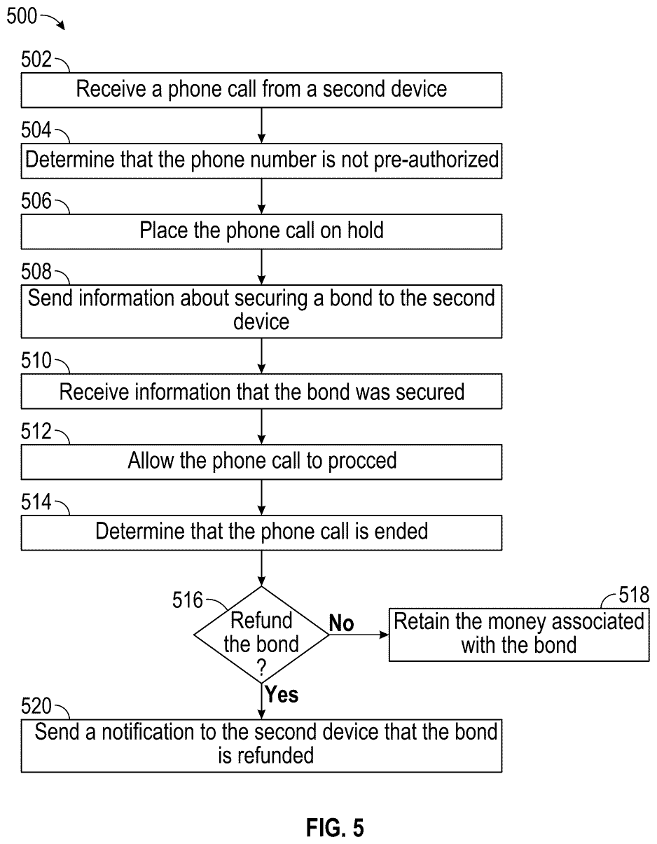

FIG. 5 illustrates a flow diagram of a process 500 according to yet another embodiment of the present disclosure. Process 500 may be performed by the user device 112 or the automotive computer 208 of the vehicle 102, or a combination thereof. At step 502, a first device receives a phone call from a second device. At step 504, the first device may check the incoming phone number and determine that the phone number is not a part of a list of preauthorized phone numbers. Based on that determination, the first device may put the phone call on hold at step 506 and send a message to the second device at step 508. The message may include information about posting a bond if the user of the second device wishes the call to proceed. As noted above, the information may include details of the bond service provider, amount of bond to be purchased, time duration allocated to the phone call based on the bond amount, etc. At step 510, the first device may receive information that the bond was purchased. For example, the bond service provider may send a message to the first device providing details of the bond that was purchased by the user of the second device.

At step 512, the phone call may be allowed to proceed upon verification that the bond was purchased. At step 514, the phone call may end or be terminated either by the first device or the second device. The first device may detect the termination or ending of the phone call and based on that, the first device may present an option to the first user to either refund the bond or retain the bond, at step 516. The option may be presented via a user interface of the first device. At step 518, the first device may receive an input from the first user indicating that the first user intends to retain the amount of the bond. In response to that, the first device may send a message to the second device that the first user will retain the amount of the bond. In another instance, the first user may decide to refund the bond amount back to the second user. The first device may receive and input, at step 520, indicating that the first user wants to refund the bond money back to the second user. The first device may then send a message to the second device indicating refund of the bond amount.

In certain instances, a user may want to accept calls from unknown or non-preauthorized phone numbers because the phone call may be important for the user. However, it is not possible for the user to know beforehand if the current incoming call is valuable/important for the user, and the user should accept the call. For example, consider a situation where a family member of the user is in need of assistance, and a stranger is providing the required assistance. If the family member uses the stranger's phone to call the user, the user may not recognize that number and ignore the call. However, in this instance, it may be beneficial for the user to accept the call as it concerns his family member. Systems and methods of the present disclosure provide a way for the user to account for such situations.

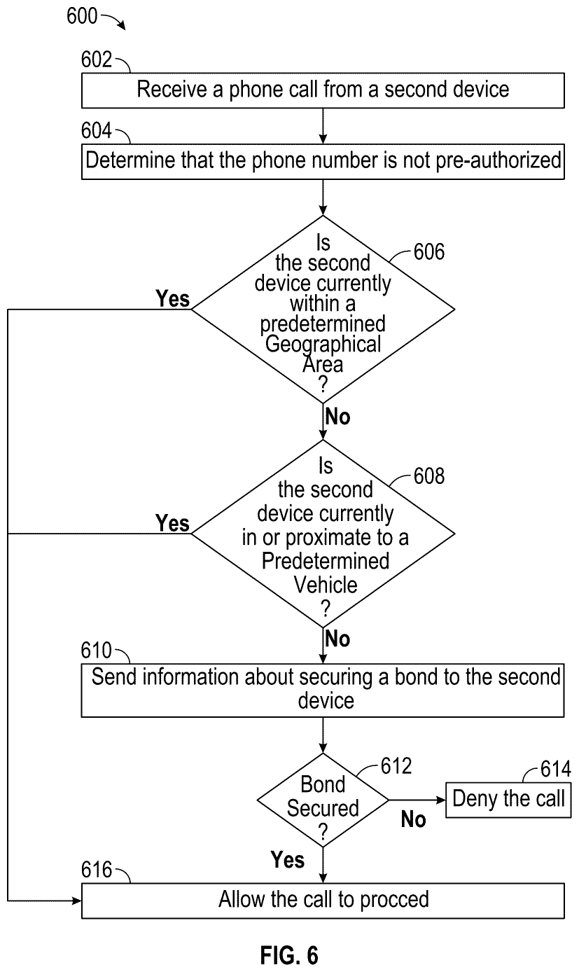

FIG. 6 illustrates a flow diagram of a process 600 according to an embodiment of the present disclosure. Process 600 may be performed by the user device 112 or the automotive computer 208 of the vehicle 102, or a combination thereof. At step 602, the first device may receive a call from a second device. At step 604, the first device may determine that the phone number associated with the second device is not part of the preauthorized list of phone numbers. However, in this instance, instead of immediately sending information about securing a bond to the second device, the first device may determine whether the second device is currently within a predetermined geographical area, at step 606. In an embodiment, the first device may query its mobile network for the location of the second device. The mobile network may determine the location of the second device using cell tower triangulation, GPS data associated with the second device, and/or Wi-Fi positioning techniques. The mobile network may then access the location data of the second device to the first device. In some embodiments, in order to protect the privacy of the second device, an approximate location of the second device may be communicated to the first device. As noted above, the user of the first device may designate certain geographical locations as being preauthorized such that if a call originates within one of the preauthorized geographical locations, then that call may be allowed to go through even if the phone number of the incoming call is not in the preauthorized phone number list. For example, the user of the first device may designate an area around the school of his/her kids, an area around the work location of one or more family members, etc. as being part of the preauthorized geographic areas. The reason being that if a call originates in one of these preauthorized geographic areas, it is unlikely that the call is robo call or other type of unwanted call and more likely that the call pertains to someone of interest to the user of the first device.

If it is determined at step 606 that the location of the second device is within one of the preauthorized geographical areas, then the call may be allowed to go through to the first device at step 616. If it is determined at step 606, that the that the location of the second device is not within one of the preauthorized geographical areas, then the first device may determine whether the location of the second device is currently proximate to one or more predetermined vehicles at step 608. The one or more predetermined vehicles may include vehicles associated with family members of the first user. In an embodiment, the user may designate a certain distance value from the current location of the one or more predetermined vehicles as being proximate. For example, a distance of between 1 meter and 3 meters may be considered proximate to the one or more predetermined vehicles. It is to be understood that the user may designate any reasonable distance for this purpose. The reason for doing this may be that if a call originates from a location proximate to a current location of the one or more predetermined vehicles, then it is likely that the call pertains to a family member of the user of the first device or someone who the first user cares about. It is likely that the phone call may be placed from a stranger's device but may be relevant to a family member. For example, consider a scenario where a family member is involved in an incident associated with his/her vehicle and is currently being assisted by a first responder or a law enforcement official and that first responder or law enforcement official is trying to reach the first user using their own phone. In this instance, it would be beneficial to allow the call to get through to the first device even if the phone number of the second device is not part of the preauthorized list of phone numbers.

At step 608, the first device may determine a current location of the one or more predetermined vehicles. This can be accomplished using an application that may track the location of the one or more predetermined vehicles. The first device may also obtain location information of the second device that originated the phone call. The first device may compare the current location of the one or more predetermined vehicles and the location information of the second device to determine whether the second device is proximate to and/or within a certain distance of the current location of the one or more predetermined vehicles. If the first device determines that the location of the second device is proximate to and/or within a certain distance of the current location of the one or more predetermined vehicles, the phone call is allowed to proceed at step 616. If the first device determines that the current location of the second device is not proximate to and/or not within a certain distance of the current location of the one or more predetermined vehicles, the first device may send information regarding purchasing a bond to the second device at step 610.

At step 612, the first device may verify whether the bond has been purchased. If the bond is purchased, the phone call may be allowed to proceed at step 616. If the first device determines that the bond is not purchased, the phone call may be denied or terminated at step 614. The steps of 610, 612, and 614 may be performed similarly to the steps explained above with reference to the other embodiments.

In some embodiments, the user receiving the call may institute a bidding process allowing the calling party to bid for the user's time. Thus, if the calling party really wants to talk to the user, they may be inclined to participate in the bidding process. The calling party may send a message to the user's device, (e.g., via SMS), while the call is on hold, indicating their bid offer. If the user wants to take the call, the user may accept the bid and request that the calling party purchase a bond for the amount that was offered. The user device may then verify the purchase of the bond and allow the call to proceed. Fleet managers may use the embodiments of the present disclosure to block robo calls or unwanted calls during business hours, so these calls do not interrupt the workers during their work hours. An automatic message may be sent to the calling party that while the worker they have called may be interested, they are currently busy and to call back at a different time outside of working hours.

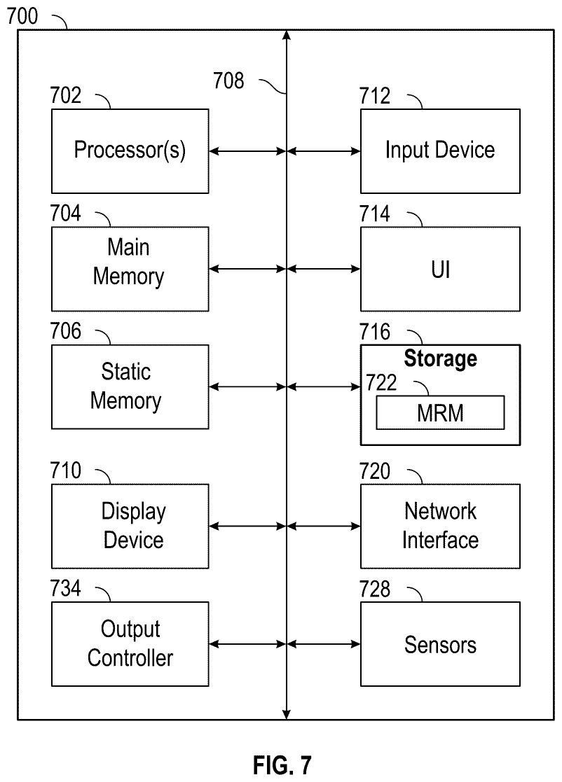

FIG. 7 depicts a block diagram of an example control server 700 (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 700 may operate as a standalone device or may be connected (e.g., networked) to other servers. In a networked deployment, the server 700 may operate in the capacity of a server machine, a client machine, or both in server-client network environments. In an example, the server 700 may act as a peer server in peer-to-peer (P2P) (or other distributed) network environments. The server 700 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include, or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The server 700 may further include a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The server 700 additionally may include a storage device (i.e., drive unit) 716, a network interface device/transceiver 720 coupled to antenna(s), and one or more sensors 728, such as a global positioning system (GPS) sensor, a compass, an accelerometer, or another sensor. The server 700 may include an output controller 734, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 716 may include a machine-readable medium 722 on which is stored one or more sets of data structures or instructions (e.g., software) embodying or being utilized by any one or more of the techniques or functions described herein. The instructions also may reside, completely or at least partially, within the main memory 704, within the static memory 706, or within the hardware processor 702 during execution thereof by the server 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as, but not limited to, read-only memory (ROM) random access memory (RAM), magnetic disk storage media, optical storage media, a flash memory, etc.

The term “machine-readable medium” may include any medium that is capable of storing, encoding, or carrying instructions for execution by the server 700 and that causes the server 700 to perform any one or more of the techniques of the present disclosure, or that is capable of storing, encoding, or carrying data structures used by or associated with such instructions. Nonlimiting machine-readable medium examples may include solid-state memories and optical and magnetic media. In an example, a massed machine-readable medium includes a machine-readable medium with a plurality of particles having resting mass. Specific examples of massed machine-readable media may include nonvolatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P 2P) networks, among others. In an example, the network interface device/transceiver 720 may include one or more physical jacks (e.g., Ethernet, coaxial, or phone jacks) or one or more antennas to connect to the communications network. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner's manual and safety guidelines. In addition, any action taken by the vehicle owner/driver based on recommendations or notifications provided by the vehicle should comply with all the rules specific to the location and operation of the vehicle (e.g., federal, state, country, city, etc.). The recommendations or notifications, as provided by the vehicle, should be treated as suggestions, and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name but not function.

It should also be understood that the word “example” as used herein, is intended to be non-exclusionary and nonlimiting in nature. More particularly, the word “example” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, nonvolatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined not with reference to the above description but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein; unless an explicit indication to the contrary is made herein. In particular, use of singular articles such as “a,” “the,” “said,” etc. should be read to recite one or more of the indicated elements; unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by a first device, a first phone call from a second device;
determining, by the first device, that a phone number associated with the second device is not part of a preauthorized list of phone numbers;
sending, by the first device to the second device, a first message including information about purchasing a bond in order for the first phone call to proceed;
receiving, by the first device, a second message indicative of the bond being purchased; and
accepting, by the first device and based on the bond being purchased, the first phone call.

2. The method of claim 1, further comprising:
prior to sending the first message, putting the first phone call on hold.

3. The method of claim 1, wherein:
receiving the second message further comprises receiving the second message from a bond service provider that issued the bond.

4. The method of claim 1, wherein:
receiving the first phone call further comprises receiving the first phone call over a first communication channel; and
sending the first message further comprises sending the first message over a second communication channel that is different from the first communication channel.

5. The method of claim 1, further comprising:
prior to sending the first message, determining, by the first device, whether a current location of the second device is within a predetermined geographic area, wherein the predetermined geographic area is associated with a user of the first device.

6. The method of claim 1, further comprising:
prior to sending the first message, determining, by the first device, whether a current location of the second device is proximate to a current location of one or more preauthorized vehicles, wherein the one or more preauthorized vehicles are associated with a user of the first device.

7. The method of claim 1, further comprising:
receiving a second phone call from a third device;
determining, by the first device, that a phone number associated with the third device is not part of the preauthorized list of phone numbers;
sending, by the first device to the second device, a third message including information about purchasing a bond in order for the first phone call to proceed;
determining, by the first device, that the third device has terminated the second phone call; and
automatically adding, by the first device, the phone number associated with the third device to a list of blocked phone numbers.

8. A method comprising:
receiving, by a first device, a first phone call from a second device;
determining, by the first device, that a phone number associated with the second device is not part of a preauthorized list of phone numbers;
determining, by the first device, whether a current location of the second device is within a predetermined geographic area, wherein the predetermined geographic area is associated with a user of the first device;
determining, by the first device, whether the current location of the second device is proximate to a current location of one or more preauthorized vehicles, wherein the one or more preauthorized vehicles are associated with a user of the first device; and
allowing, by the first device, the first phone call to proceed if the current location of the second device is within the predetermined geographic area or if the current location of the second device is proximate to the current location of one or more preauthorized vehicles.

9. The method of claim 8, further comprising:
sending, by the first device to the second device, a first message instructing the user of the second device to purchase a bond to proceed with the first phone call if the current location of the second device is not within the predetermined geographic area or if the current location of the second device is not proximate to the current location of one or more preauthorized vehicles.

10. The method of claim 9, further comprising
receiving, by the first device, a second message from the second device, the second message indicating that the bond has been purchased; and
allowing, by the first device, the first phone call to proceed based on the bond being purchased.

11. The method of claim 10, further comprising:
determining, by the first device, that the first phone call has ended; and
automatically refunding the bond to the user of the second device.

12. The method of claim 9, further comprising:
determining, by the first device, that the first phone call is terminated by the second device without purchasing the bond; and
automatically adding, by the first device, the phone number associated with the second device to a list of blocked phone numbers.

13. The method of claim 8, wherein:
determining whether the current location of the second device is within a predetermined geographic area further comprises receiving, by the first device from a first mobile network associated with the first device, the current location of the second device.

14. The method of claim 8, wherein prior to determining that the phone number associated with the second device is not part of a preauthorized list of phone numbers, placing the first phone call on hold.

15. A vehicle comprising:
an automotive computer including a communication interface configured to communicate over a mobile phone network; and
a memory device coupled to a vehicle control unit and storing instructions that, when executed by the controller, causes the automotive computer to:
receive a first phone call from a first device;
determine that a phone number associated with the first device is not part of a preauthorized list of phone numbers;
place the first phone call on hold;
send a first message to the first device, the first message instructing a user of the first device to purchase a bond;
receive a second message indicating that the user of the first device has purchased the bond; and
allowing the first phone call to proceed based on the bond being purchased.

16. The vehicle of claim 15, wherein the automotive computer receives the first phone call over a first communication channel and the automotive computer sends the first message over a second communication channel that is different from the first communication channel.

17. The vehicle of claim 15, wherein prior to sending the first message, the automotive computer determines whether a current location of the first device is within a predetermined geographic area, wherein the predetermined geographic area is associated with a user of the vehicle.

18. The vehicle of claim 15, wherein the instructions further cause the automotive computer to:
receive a second phone call from a second device;
determine that a phone number associated with the second device is not part of the preauthorized list of phone numbers;
send a third message to the second device, the third message including information about purchasing a bond in order for the first phone call to proceed;
determine that the second device has terminated the second phone call; and
automatically add the phone number associated with the second device to a list of blocked phone numbers.

19. The vehicle of claim 15, wherein prior to sending the first message, the automotive computer determines whether a current location of the first device is within a predetermined distance of a current location of one or more vehicles associated with the user of the vehicle.

20. The vehicle of claim 15, wherein the instructions further cause the automotive computer to receive the second message from a bond service provider that issued the bond.
